(19) United States
(12) Patent Application Publication
(10) Pub. No.: US 2026/0112340 A1
(43) Pub. Date: Apr. 23, 2026

(54) ADJUSTABLE DRUM STAND BASKET AND DRUM STAND

(71) Applicant: DRUM WORKSHOP, INC., Oxnard, CA (US)

(72) Inventor: Ruben STEINHAUSER, Altusried (DE)

(21) Appl. No.: 18/918,706

(22) Filed: Oct. 17, 2024

(51) Int. Cl. G10D 13/10

(52) U.S. Cl. CPC G10D 13/28

(57) ABSTRACT

Disclosed herein are adjustable and collapsible snare drum baskets. One embodiment of a basket according to the present disclosure comprises a threaded spindle, a fixed bracket, and a suspended bracket movably connected to the fixed bracket by a plurality of arms each comprising a plurality of movably coupled braces. The plurality of arms define a diameter for a drum. The fixed bracket can act as a nut for the spindle. The knob can be used to adjust the spindle upwards or downwards through the fixed bracket to in turn adjust the height of the suspended bracket and the overall diameter of the basket. At a certain height, the suspended bracket causes the arms to collapse and become substantially vertical and/or substantially parallel to the threaded spindle, aiding in transportability.

### BACKGROUND

### 1. Field of the Disclosure

The present disclosure relates generally to drum stands, and in particular to drum stands with adjustable drum baskets, including snare drum stands and adjustable snare drum baskets and tom stands and adjustable tom baskets.

### 2. Description of the Related Art

Snare drums are common and widely used percussion instruments. The snare drum can sometimes be the center component and most prominent piece in a drum set. Snare drums are frequently used in orchestras, marching bands, concert bands, parades, drum corps, and many other applications. The snare drum is highly accessible and often used as a teaching aid for new drummers.

Snare drums are usually double-sided drums, such that either head of the drum can be struck. Snare drums often come equipped with rattles, also called snares, metal wire, synthetics, and/or other devices that are stretched across one, or sometimes both, of the drum heads. Usually, a single set of snares is on the underside of the bottom, or unplayed, drum head. When the top drum head is struck, the snares on the bottom drum head resonate to give the snare drum its distinctive rattle sound. Band/orchestral, drum kit, and marching snare drums often use this type of snare.

Snare drum stands may be used to hold the snare drum in place for actuation by a user. Some snare drum stands and baskets with components that can be incorporated into embodiments of the present disclosure are described in U.S. Pat. No. 8,395,039 to Steinhauser et al., which is fully incorporated by reference herein. Such snare drum stands are often used in settings where the drummer is sitting, such as in bands/orchestras and drum kits. Many snare drum stands include a mechanism for adjusting the height and/or the diameter defined by the basket to switch out the snare for one of a different size. However, these mechanisms often inadvertently adjust, even if minimally, the angle of the plane on which the snare drum sits rather than keeping all planes parallel to one another.

Another common problem with snare drum stands is that they, especially the snare drum baskets, often lack the ability to easily and completely collapse, which makes the stands difficult to store and/or transport. Snare drum stands with baskets that completely close often do not have the ability to easily adjust the diameter of the snare drum basket, and thus the snare drum, while keeping the portions of the arms on which the snare sits parallel to one another.

Accordingly, there is a present need for a novel and efficient design for a drum stand, such as a snare drum stand, which specifically deals with the aforementioned problems.

### SUMMARY OF THE DISCLOSURE

Disclosed herein are adjustable and collapsible drum baskets and drum stands, such as, by way of example, snare stands and baskets, and tom stands and baskets.

One embodiment of a drum basket according to the present disclosure comprises a fixed bracket and a suspended bracket vertically adjustable relative to the fixed bracket. A plurality of arms is each connected to the fixed bracket and the suspended bracket. The arms are movably coupled to the suspended bracket such that the arms define a range of drum diameters dependent on the height of the suspended bracket relative to the fixed bracket.

Another embodiment of a drum basket according to the present disclosure comprises a spindle, a receiver for the spindle, and a plurality of arms movably coupled to the receiver. The spindle is configured to vertically adjust the receiver.

Yet another embodiment of a drum basket according to the present disclosure comprises a fixed bracket and a suspended bracket vertically adjustable relative to the fixed bracket. Each of a plurality of arms comprises at least two parallel braces, with each of the arms connected to the fixed bracket and the suspended bracket. The arms are movably coupled to the suspended bracket such that the arms define a range of drum diameters dependent on the height of the suspended bracket relative to the fixed bracket, and such that the parallel braces in each of the arms remain parallel to each other regardless of the height of the suspended bracket.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 is a perspective view of one embodiment of a drum stand according to the present disclosure with the drum basket at its lowest height and widest diameter;

FIG. 2 is a perspective view of the basket of the drum stand shown in FIG. 1;

FIG. 3 is a cross-sectional view of a portion of the drum basket shown in FIG. 2;

FIG. 4 is another perspective view of the drum basket shown in FIG. 2;

FIG. 5 is another perspective view of the drum basket shown in FIG. 2; and

FIG. 6 is a side view of the drum stand shown in FIG. 1 with the drum basket fully closed.

### DETAILED DESCRIPTION OF THE DISCLOSURE

Disclosed herein are drum stands and baskets, such as snare stands, snare baskets, tom stands, and tom baskets. Some drum stands according to the present disclosure include adjustable and collapsible baskets. One embodiment of such a basket comprises a threaded spindle with a knob connected at a bottom end of the spindle, a fixed bracket with a hollow threaded portion configured to accept the threaded spindle, a suspended bracket situated at a top end of the spindle that is height-adjusted by the threaded spindle. The fixed bracket does not move as the threaded spindle is rotated through it. On the other hand, the suspended bracket rests on the top end of the threaded spindle, thus the top end of the threaded spindle lowers, raises, or maintains the height of the suspended bracket.

In one embodiment, the knob can be connected to the spindle at one end, and the spindle can pass through the fixed bracket. The suspended bracket can be positioned at the other end of the spindle. The fixed bracket can have a fixed location and/or can serve as a nut for the spindle. The knob can be used to adjust the spindle upwards or downwards through the fixed bracket, in turn adjusting the height of the suspended bracket. The suspended bracket can be mechanically linked to the plurality of arms, such that as the suspended bracket moves upward, it draws the arms upward and inward such that they form a smaller diameter; and such that as the suspended bracket moves downward, it allows the arms to move downward and outward such that they form a larger diameter.

In one embodiment, at its highest point, the suspended bracket reaches a position that causes and/or allows the arms to fully close or collapse, promoting portability of the drum stand. The basket can also be detachable from a base of the drum stand for further portability.

In the following detailed description, numerous specific details are set forth in order to provide a more thorough understanding of embodiments incorporating features of the present disclosure. However, it will be apparent to one skilled in the art that devices, methods, and assemblies according to the present disclosure can be practiced without necessarily being limited to these specifically recited details.

Embodiments of the disclosure are described herein with reference to illustrations that are schematic illustrations of embodiments of the disclosure. As such, the actual size, components and features can be different, and variations from the shapes of the illustrations as a result, for example, of technological capabilities, manufacturing techniques and/or tolerances are expected. Embodiments of the disclosure should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the disclosure. In addition, components may be shown as one unit but may instead be a collection of components or units, or a collection of components or units may exist as one unit.

Throughout this description, the preferred embodiment and examples illustrated should be considered as exemplars, rather than as limitations on the present disclosure. As used herein, the term “disclosure,” “device,” “assembly,” “system” “method,” “present disclosure,” “present device” or “present method” refers to any one of the embodiments of the disclosure described herein, and any equivalents. Furthermore, reference to various feature(s) of the “disclosure,” “device,” “assembly,” “system,” “method,” “present disclosure,” “present device” or “present method” throughout this document does not mean that all claimed embodiments or methods must include the referenced feature(s).

It is also understood that when an element or feature is referred to as being “on” or “adjacent” another element or feature, it can be directly on or adjacent to the other element or feature, or intervening elements or features may also be present. It is also understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

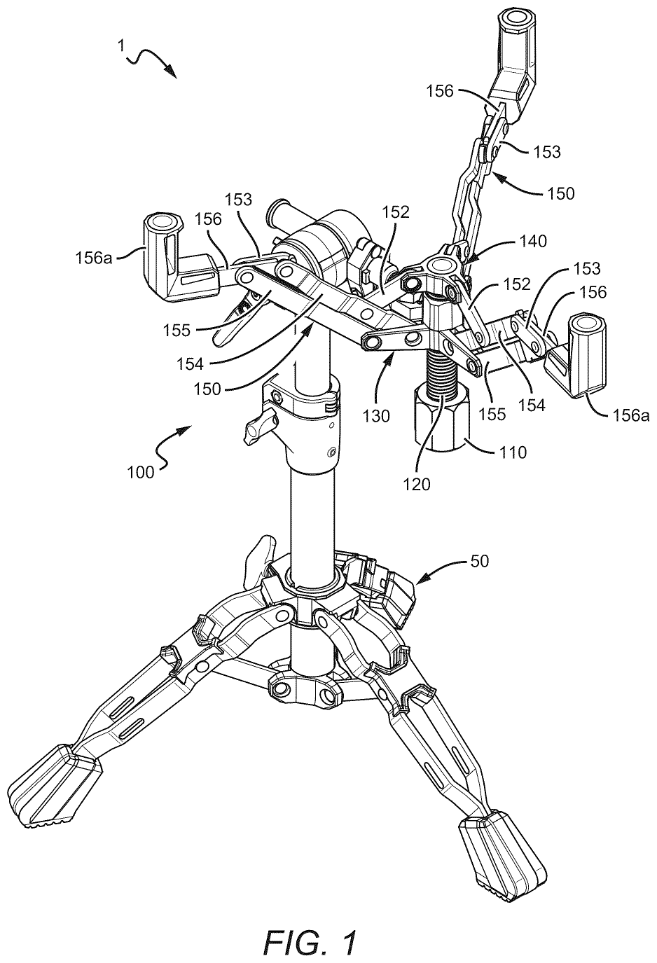

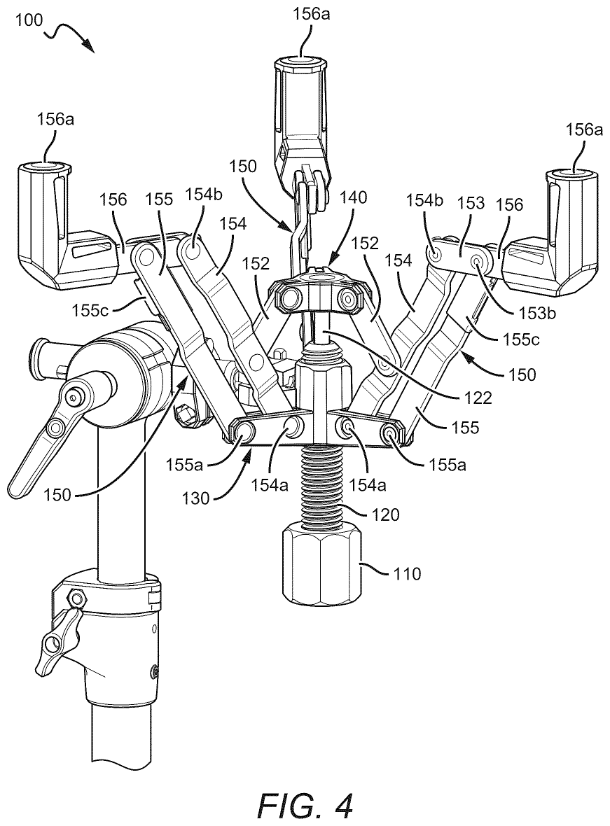

FIGS. 1-6 show one embodiment of a drum stand 1 with a base 50 and an adjustable and collapsible snare basket 100 according to the present disclosure. The angle of the snare basket 100 relative to the base 50 can be adjusted utilizing means known in the art. The basket 100 comprises a threaded spindle 120 with a knob 110 at a bottom end; a fixed bracket 130 with a hollow threaded aperture 132 configured to accept the threaded spindle 120 and through which the spindle 120 may pass; a suspended bracket 140 on top of the spindle 120; and a plurality of arms 150 connecting the fixed bracket 130 and the suspended bracket 140. The suspended bracket 140 may be affixed to the spindle 120, or may rest on top of it without being affixed. The figures show an embodiment with three arms 150, but it is understood that there may be a different number of arms, such as four arms, five arms, or more.

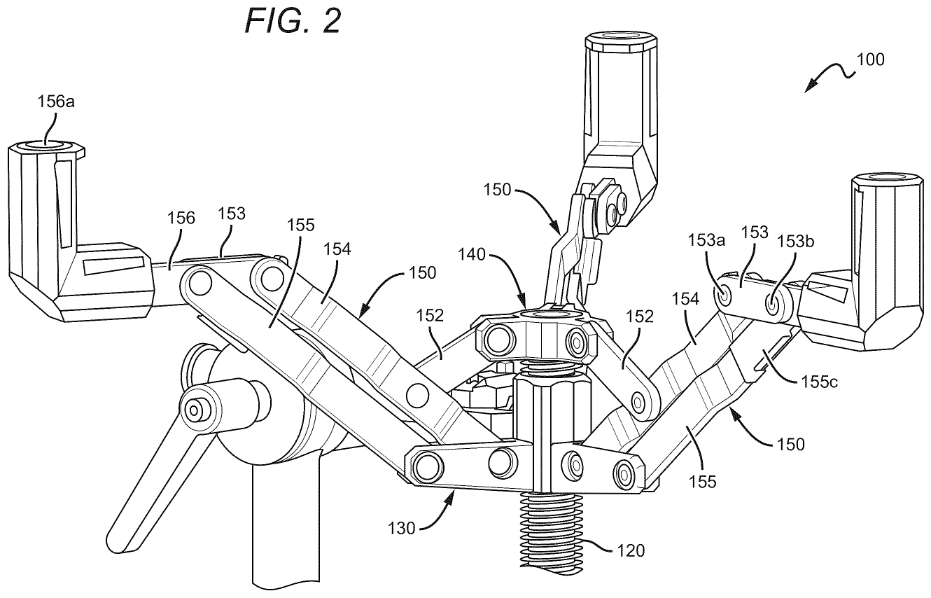

The plurality of arms 150 define a diameter for a drum, such as a snare drum or tom. Depending on whether the knob 110 is rotated clockwise or counterclockwise, it either moves (1) vertically upwards through the fixed bracket 130 towards the suspended bracket 140, pushing the suspended bracket 140 vertically up, or (2) vertically downwards, in turn causing the suspended bracket 140 to move vertically downwards (e.g., due to gravity, or because the suspended bracket is affixed to the spindle 120). FIGS. 2, 4, 5, and 6 show the suspended bracket 140 at various heights utilizing the knob 110 and threaded spindle 120, and, in turn, the plurality of arms 150 at various diameters.

Embodiments of the basket 100 can have various different minimum diameters (e.g., when the suspended bracket 140 is at its highest point such that the holding braces 156 are maximally drawn inward) and maximum diameters (e.g., when the suspended bracket 140 is at its lowest point such that the holding braces 156 are maximally extended outward) (with diameter in these instances referring to the internal diameter that is used to hold a drum, e.g., defined by the hooked portions of the holding braces 156 and/or the covers 156a). Some embodiments have a minimum diameter or 4″ or more, 5″ or more, 6″ or more, 8″ or more, 10″ or more, between 4″ and 12″, between 6″ and 10″, 14″ or less, 12″ or less, 10″ or less, or combinations of these. Some embodiments have a maximum diameter of 8″ or more, 10″ or more, 12″ or more, 14″ or more, 15″ or more, 17″ or more, 20″ or more, 10″ to 20″, 12″ to 18″, 14″ to 16″, 20″ or less, 17″ or less, 15″ or less, or combinations of these. Combinations of any of these minimum diameter ranges and maximum diameter ranges are possible, as are embodiments with dimensions outside those explicitly listed here.

Each arm 150 can comprise a plurality of braces. In the specific embodiment shown, each arm 150 includes five braces 152,153,154,155,156, though it should be understood that fewer or more brackets are possible. The braces 152,153,154,155,156 can be pivotably coupled to one another, to the fixed bracket 130 (e.g., to a fixed arm 130a of the fixed bracket 130), and/or to the suspended bracket 140. When the suspended bracket 140 moves upwards, the diameter defined by the arms 150 decreases. The lower the suspended bracket 140 sits, the larger the diameter defined by the arms 150, and thus the larger the drum that can be held by the basket 100.

Each arm 150 may comprise junction braces 152,153, intermediate braces 154,155 and/or holding braces 156. In one specific embodiment, each arm 150 comprises two junction braces 152,153, two intermediate braces 154,155 (which can be, e.g., between and/or connecting junction braces, and/or between and/or connecting a junction brace and a holding brace, and/or connecting to a junction brace and/or a holding brace), and one holding brace 156 (which can be used to hold a drum). The various braces described herein may have many different dimensions. Some embodiments utilize braces having lengths between 0.5″ and 12″, and/or between 1″ and 9″, and/or between 1.5″ and 7″. In some embodiments, one, more than one, or all of the intermediate braces have dimensions of 2.5″ or greater, or 4″ or greater, or 5.5″ or greater, or between 2.5″ and 10″, or between 4″ and 7″. In some embodiments, one, more than one, or all of the intermediate braces 154,155 are longer than one, more than one, or all of the junction braces 152,153. The junction braces 152,153 may have the same length or have differing lengths. Likewise, the intermediate braces 154,155 may have the same length or different lengths. In a preferred embodiment, the intermediate braces 154,155 have the same length as one another and/or the junction braces 152,153 differ in length from one another. It is understood that different numbers of junction, intermediate, and holding braces are possible; these one or more of these brace types could be omitted; that other brace types could be included; and/or that different braces could be combined into a single brace (e.g., the junction brace 153 and the holding brace 156). In some embodiments, the holding brace 156 is hook-shaped and/or L-shaped, but it is understood that the holding brace 156 may have other shapes as well, and/or an additional component may provide a non-straight shape.

Of the two intermediate braces 154,155 there is a top brace 154 and a bottom brace 155. The intermediate braces 154,155 each have an upper end and a lower end. As best shown in FIG. 2, the first junction brace 152 is pivotably connected to the suspended bracket 140 at one end 152a and to the top intermediate brace 154 at the junction brace's other end 152b. The second junction brace 153 is pivotably connected to the two intermediate braces 154,155 at their upper ends 153a,153b. The top intermediate brace 154 has a pivot connection point 154a at its bottom end that pivotably connects to the fixed bracket 130 (e.g., to an arm 130a thereof) and a connector 154b at its top end. In the embodiment shown, the connector 154b is a connector such as a peg 154b (e.g., a cylindrical peg). The bottom intermediate brace 155 has a pivot connection point 155a at its lower end that pivotably connects to the fixed bracket 130 (e.g., to the arm 130) and another pivot connection point 153b at its top end that pivotably connects through the holding brace 156 to the second junction brace 153.

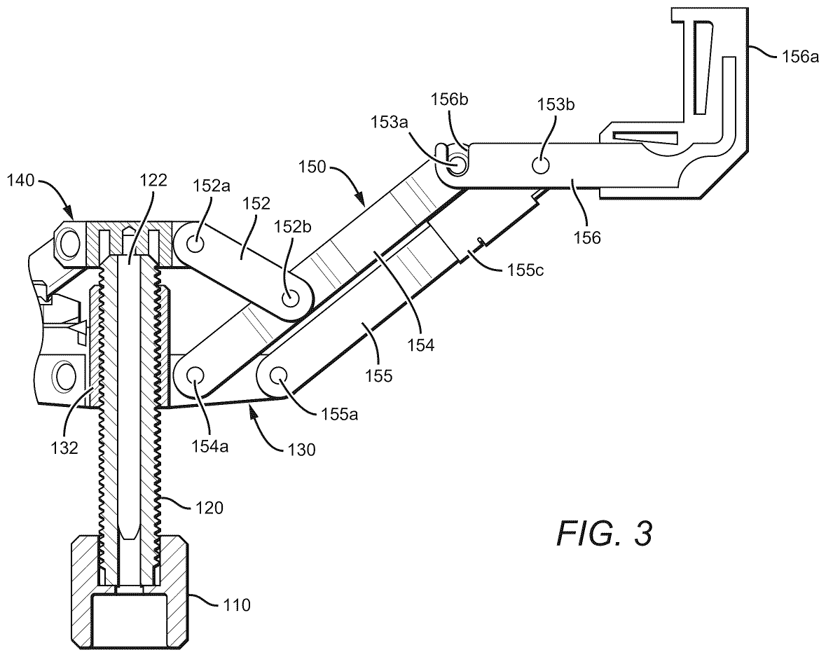

The holding brace 156 is configured to rotatably pivot around the connection point 153b. As shown in FIGS. 1, 2, 4, and 5, the holding braces 156 of the arms 150 can be substantially co-planar with one another, and/or configured to hold and secure a drum; though it should be understood that non-co-planar embodiments are possible. In some embodiments, the holding brace 156 is L-shaped and/or hook-shaped, but it is understood that other shapes are possible. In the embodiment shown in FIG. 3, the holding brace 156 is L-shaped/hook-shaped with one end covered or attached to a cover 156a. The cover 156b may be comprised of rubber or any other material that creates a non-destructive friction between the cover 156a and a drum.

On the end that is not covered, the holding brace 156 is configured to removably connect its inner end 156b to the peg 154b of the top intermediate brace 154. As best shown in FIG. 3, the holding brace 156 is configured with a cutout (e.g., a U-shaped cutout) 156b that is configured to hook onto the peg 154b and secure the holding brace 156 in its horizontal, deployed position.

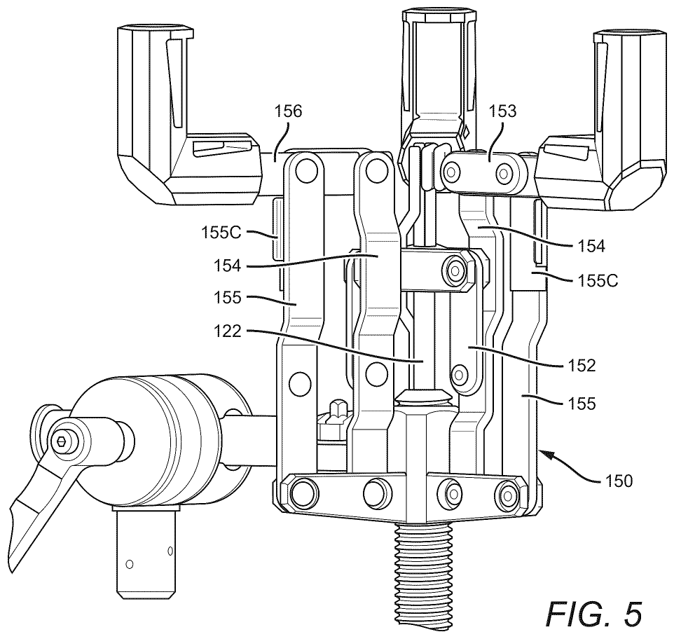

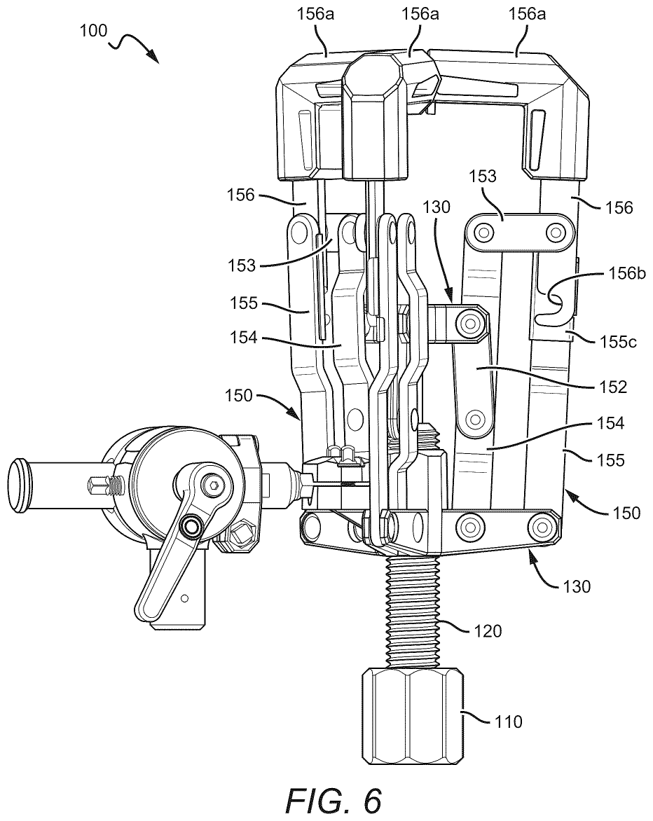

FIG. 5 shows the suspended bracket 140 at a height where the intermediate braces 154,155 are substantially perpendicular to the fixed bracket. The basket 100 shown in FIG. 5 is nearly collapsed. As best shown in FIG. 6, the holding brace 156 may disconnect from the peg 154b and rotate around the connection point 153b between the holding brace 156 such that the outer end 156a of the holding brace 156 moves towards the center of the basket 100. This allows for the holding brace 156 to become substantially parallel with the intermediate braces 154,155 and for the basket to collapse for transportation and/or storage purposes. When collapsed or closed, as exemplified in FIG. 6, the intermediate braces 154,155 and the holding brace 156 are substantially parallel to the threaded spindle 120 and/or are substantially vertical. The connector 154b can also serve to connect (e.g., rotatably connect) the top intermediate brace 154 with the junction brace 153.

When collapsed or closed, the holding brace 156 may be held in a collapsed or closed position by a stopper component 155c. The stopper component 155c shown in FIGS. 2-6 utilizes friction and a tab to keep the holding brace 156 in its closed position, but it is understood that other methods of keeping the holding brace 156 in its closed position are possible. For example, magnets could be placed within the covers 156a at the points the covers 156a meet when the holding brace 156 is in its closed position.

One of the main purposes of the holding braces 156 is to hold and secure a drum. To help achieve this purpose, the holding braces 156 in the basket 100 can be substantially co-planar with one another so that the drum is secure and remains fixed while in use. The holding braces 156 can stay co-planar after the height of the suspended bracket 140 and the diameter of the arms 150 are adjusted. The two intermediate braces 154,155 are situated parallel to one another and remain parallel to one another even as they move. The parallel configuration of the intermediate braces 154,155 ensures that the holding braces 156 and/or the top ends of the intermediate braces 154,155 of all the arms 150 stay co-planar with one another, and/or parallel to the ground when the stand 1 is in an untilted configuration and/or when the snare is situated.

The diameter defined by the arms 150 directly correlates to the height of the suspended bracket 140. The height of the suspended bracket 140 may be adjusted by the threaded spindle 120. In one embodiment, because the suspended bracket 140 is not affixed to either the spindle 120 or the fixed bracket 130, it may also be manually adjusted (e.g., pulled upward) by a user to its highest point to quickly collapse the arms, while maintaining the threaded spindle 120 at a height corresponding to the diameter of the drum that was being played. In this way, the stand 100 can easily be redeployed to its previous position by adjusting the suspended bracket 140 back downward to engage the threaded spindle 120. Regardless of whether the threaded spindle 120 is affixed to the suspended bracket 140 or not, the suspended bracket 140 can include an aperture in an underside thereof for accommodating an end of the threaded spindle 120 to provide for a more stable connection between the two. When the basket 100 is in its collapsed state, a holder can be used to keep the basket 100 in its collapsed state, such as an elastic holder (e.g., a rubber band). Many different holding mechanisms are possible.

In some embodiments, the threaded spindle 120 and the suspended bracket 140 are configured with a locking mechanism to secure the suspended bracket 140 at a specific height and the arms 150 at a specific diameter. For example, as shown in FIGS. 3-6, the locking mechanism may be male-female connectors. The threaded spindle 120 may further comprise a male connector, such as a pin 122 that is configured to be inserted into a female connector on the suspended bracket 140, and this pin holds suspended bracket 140 in place when it is at a desired height and the arms 150 are at a desired diameter.

Utilizing the locking mechanism 122, the threaded spindle 120 also can serve as a memory lock for baskets according to the present disclosure. The locking mechanism 122 can be used to holding the suspended bracket 140 at a collapsed height while the threaded spindle 120 remains at a specific height for the suspended bracket 140. When the locking mechanism 122 is released down to a height substantially near the suspended bracket's height 140, the suspended bracket 140 will then adjust to the previously set, specific height, and thus the previously set, specific diameter.

Although FIGS. 1-6 show embodiments of a basket according to the present disclosure attached to a percussion stand (e.g., at the top of a stand to secure a drum or snare), baskets according to the present disclosure may also be mounted or clamped to the side of a drum rack.

It is understood that embodiments presented herein are meant to be exemplary. Although the present disclosure has been described in detail with reference to certain preferred configurations thereof both in the specification and in the claims, other versions are possible. Embodiments of the present disclosure can comprise any combination of compatible devices/features described herein and/or shown in the figures, and these embodiments should not be limited to those expressly illustrated and discussed. For instance and not by way of limitation, the appended claims could be modified to be multiple dependent claims so as to combine any combinable combination of elements within a claim set, or from differing claim sets. Claims depending on one independent claim could be modified so as to depend from a different independent claim. Therefore, the spirit and scope of the disclosure should not be limited to the versions described above.

While the foregoing written description of the disclosure enables one of ordinary skill to make and use what is considered presently to be the best mode thereof, those of ordinary skill will understand and appreciate the existence of variations, combinations, and equivalents of the specific embodiments, methods, systems, and examples herein. The disclosure should therefore not be limited by the above-described embodiments, methods, systems, and examples. Furthermore, certain terminology has been used for the purposes of descriptive clarity, and not to limit the present disclosure. It is therefore intended that the following appended claims include all such alterations, modifications and permutations as fall within the true spirit and scope of the present disclosure. No portion of the disclosure is intended, expressly or implicitly, to be dedicated to the public domain if not set forth in the claims.

I claim:

1. A drum basket comprising:
a fixed bracket;
a suspended bracket vertically adjustable relative to said fixed bracket;
a plurality of arms each connected to said fixed bracket and said suspended bracket, wherein said arms are movably coupled to said suspended bracket such that said plurality of arms defines a range of drum diameters dependent on a height of said suspended bracket relative to said fixed bracket.

2. The drum basket of claim 1, further comprising a threaded spindle, wherein said fixed bracket defines a hollow threaded center configured to receive said threaded spindle.

3. The drum basket of claim 2, wherein said threaded spindle is configured to vertically adjust the height of said suspended bracket relative to said fixed bracket.

4. The drum basket of claim 2, wherein said threaded spindle is not affixed to said suspended bracket.

5. The drum basket of claim 2, further comprising a knob on a bottom of said spindle.

6. The drum basket of claim 1, comprising at least three of said arms.

7. The drum basket of claim 1, wherein each of said arms comprises a top intermediate brace and a bottom intermediate brace each comprising an upper end and a lower end, wherein said lower ends of said top and bottom intermediate braces are pivotably connected to said fixed bracket, and said upper ends of said top and bottom intermediate braces are connected by a first junction brace.

8. The drum basket of claim 7, wherein said top and bottom intermediate braces are substantially parallel to one another.

9. The drum basket of claim 7, wherein said drum basket is collapsible such that the top and bottom intermediate braces of each of said arms are substantially vertical.

10. The drum basket of claim 1, wherein each of said arms comprises:
a holding brace;
a top intermediate brace and a bottom intermediate brace each with an upper end and a lower end, wherein said lower ends of said top and bottom intermediate braces are pivotably connected to said fixed bracket, said upper end of said bottom intermediate brace is pivotably connected to said hook brace, and said upper end of said top intermediate brace is configured with a connector and said hook brace is configured to removably connect to said connector; and
a first junction brace and a second junction brace, wherein said first junction brace is pivotably connected to said suspended bracket at one end and to said top intermediate brace at said first junction brace's other end, and said second junction brace is connected to said upper ends of said top and bottom intermediate braces.

11. The drum basket of claim 10, wherein said connector is a peg and said holding brace further comprises a notch configured to removably connect to said peg.

12. The drum basket of claim 10, wherein said holding brace is hook-shaped.

13. The drum basket of claim 10, wherein said top and bottom intermediate braces are substantially parallel to one another.

14. The drum basket of claim 1, wherein said threaded spindle and said suspended bracket are affixed to one another.

15. The drum basket of claim 1, wherein said range of drum diameters includes a minimum diameter of 10″ or less, and a maximum diameter of 12″ or more.

16. The drum basket of claim 1, further comprising a locking mechanism for removably locking said threaded spindle to said suspended bracket.

17. The drum basket of claim 16, wherein said locking mechanism comprises a male connector on said threaded spindle and a corresponding female connector on said suspended bracket.

18. A drum basket, comprising:
a spindle;
a receiver for said spindle; and
a plurality of arms movably coupled to said receiver;
wherein said spindle is configured to vertically adjust said receiver.

19. The drum basket of claim 18, wherein said spindle is attached to said receiver.

20. The drum basket of claim 18, wherein said spindle is configured to utilize gravity to vertically adjust said receiver.

21. The drum basket of claim 18, wherein said plurality of arms defines a range of diameters dependent on a height of said receiver.

22. A drum basket, comprising:
a fixed bracket
a suspended bracket vertically adjustable relative to said fixed bracket; and
a plurality of arms, each of said arms comprising at least two parallel braces, each of said arms connected to said fixed bracket and said suspended bracket;
wherein said arms are movably coupled to said suspended bracket, said arms defining a range of drum diameters dependent on a height of said suspended bracket relative to said fixed bracket, and wherein said parallel braces of said arms remain parallel regardless of said height of said suspended bracket.
